(19) United States
(12) Patent Application Publication
(10) Pub. No.: US 2025/0330675 A1
(43) Pub. Date: Oct. 23, 2025

(54) Mobile Instrument System with Communication Feature

(71) Applicant: WhitServe LLC, Stamford, CT (US)

(72) Inventors: Wesley W. Whitmyer, Jr., Stamford, CT (US); Declan W. Whitmyer, Stamford, CT (US)

(21) Appl. No.: 19/175,134

(22) Filed: Apr. 10, 2025

Related U.S. Application Data
(60) Provisional application No. 63/635,954, filed on Apr. 18, 2024.

(51) Int. Cl. H04N 21/462; H04N 21/438; H04N 21/482

(52) U.S. Cl. CPC H04N 21/4622; H04N 21/4383; H04N 21/482

(57) ABSTRACT

A mobile computing device executes an app that is used to implement an instrument system or an ordering system that has a communication feature, in which the users of the app can create or join communication channels. Each of the instances of the app displays a list of channels, which may be ordered/organized by a given instance according to distance(s) of that instance from the source(s) of the channels, and/or by categories of goods or services that are offered via the channels.

### TECHNICAL FIELD

This disclosure relates to wireless communication technology, and, more particularly, relates to audio and/or video communication at ranges of up to or more than 5 miles.

### BACKGROUND

In the conduct of sailboat races, and more generally in recreational boating or marine navigation, communication is of paramount importance. From the flags and/or cannons that have been used for centuries to signal the start of a regatta, to modern modes of communication such as VHF radio, the race committee tries to maintain contact with each and every boat in the race. Communication is important both for controlling the race (e.g., signaling the start, directing course changes) and also for safety (e.g., calling off the race due to an inclement forecast or mishap).

Frequently, VHF radio is used to coordinate races. However, there are some known problems with VHF. One is the range limitation. VHF radio communications are fairly comprehensible out to about 1 mile. Beyond that distance, clarity and signal strength fall off. Another is channel crowding. The competitors in a sailboat race seldom are the only people trying to use the VHF range in a given piece of water. Also, it can be difficult to control who is communicating at any given time on a given VHF channel. There can be crosstalk that inhibits the ability of the race committee to communicate with competitors. Additionally, it is well known that at the start of a sailboat race there is difficulty and confusion in coordinating what radio channel will be used. Thus, it would be desirable to have a mode of communication that has greater range and clarity, better control of communication, and easier access for users, than what can be achieved with VHF radio or with older means of signaling.

Additionally, the captain of a racing sailboat is presented with many concerns while engaged in a race. Among other things, she or he may be considering wind direction, wind speed, speed over ground, heading, angle of tack, sail shape, boom position, rudder position, distance to mark, position with respect to mark, position with respect to neighboring boats, position with respect to navigational hazards, depth under keel, communications from neighboring boats, reports from and directions to the boat crew, and instructions from the race committee.

With particular reference to directing the boat crew, a captain confronts the problem that a racing sailboat has a lot of wind noise. Shouting to be heard can quickly strain the voice, and even so, the crew may not be able to understand the first iteration of a command.

Although this disclosure uses sailboat races as an example practical application of the disclosed technology, it may be applicable to other settings (e.g., emergency response; construction crews; warehouse workers; proximity advertising for businesses such as food service or personal care businesses).

### SUMMARY

Embodiments of the disclosure provide a short-to-mid-range audio and/or visual communication system in which a would-be participant may access a list of available communications channels, select a channel, and begin communicating on the channel. In some embodiments, the would-be participants also may select a role in the channel, e.g., “listener only” or “two-way.” In other embodiments, the creator or source of the channel may assign such roles to participants.

In some embodiments, the list of channels may be sorted by physical distance from the would-be participant to the channel creator or source. For example, in context of a sailboat race, there may be multiple competitors on each boat. The captain of each boat, and the race committee, may each establish a respective channel in the system. Then the crew of each boat can see a list of channels in which their captain's channel is at the top of the list (closest source) while the other captains' channels are further down the list and the race committee channel may be anywhere in the list. As another example, in context of a food service business in a downtown area, passersby may be looking for lunch. Given an embodiment of the technology disclosed herein, a passerby may look at a list of restaurant channels sorted by distance from the passerby, may select a channel and may make a reservation or order takeout via the selected channel. In some implementations, the list of channels may be limited to a specific range, e.g., 1 mile, 5 miles, 10 miles, 20 miles, etc.

For ease of figuring out which channel(s) to access, the channels within a list may have alphanumeric identifiers, e.g., “Springheel” for the captain of a boat with that name and “MYC Race Committee” for the race committee of a given regatta.

Unlike conventional handheld radio (e.g., VHF) systems, the disclosed technology is not range-limited by the available electrical power or antenna configuration of the handheld unit. This is because the communication is routed via larger base station antennas, which have enhanced capabilities for reception and transmission as compared to the handheld units. Additionally, the base station antennas may be networked with each other. Conceivably, the disclosed technology may function at a global range. For example, the disclosed technology may be implemented using cellular or satellite telephones.

Additionally, unlike VHF, the disclosed technology is not limited to audio. In context of a sailboat race, selecting a channel may result in a video display on the user's device; e.g., a timer countdown to race start together with audio communication between the user and the race committee. In context of a restaurant in a downtown area, selecting the restaurant's channel may result in display of a dining menu in conjunction with establishing audio communication.

Referring again to the sailboat race example, a boat captain may use an implementation of the disclosed technology to set up a boat intercom channel using an app on their cellular telephone and to also join a race committee channel using the same app. On the boat intercom channel, the captain may be a speaking participant; on the race committee channel, the captain may be in “listen only” or “push-to-talk” mode. Similarly, members of the boat's crew may join the boat intercom channel on their instances of the app, either as speaking participants, listening participants, or push-to-talk participants. The captain may simultaneously or near-simultaneously listen to the race committee and instruct their crew, using the single app on the single device. Spectators to the race also may join as listening participants.

Within a given event there may be distinct channels for a sailing coach (who can use the channel to communicate with their boat or boats between races), a class of boat (e.g., when there are two different classes of boat on the same race course), a race course (e.g., when there are multiple courses being sailed within the same regatta), and/or a safety monitor (e.g., one or more safety boat(s) and/or a coast guard station or harbor master).

Another aspect of the disclosed technology is a conversation history. A given channel may include a series of recorded audio broadcasts or “squawks” from the various channel participants who have speaking permissions. A participant who has missed some of the conversation in the channel may select a squawk to replay it after the fact. In some implementations, the app may transcribe a squawk into a textual representation. In some implementations, the app may provide a textual summary of a squawk, and/or label the squawk with the identity of the participant who produced it.

Another aspect of the disclosed technology is an ability to monitor multiple channels as a listening participant.

Another aspect of the disclosed technology is a visual display of information from a channel. For example, in a sailboat race implementation of the technology, the race committee may broadcast well-known flag signals in combination with audio instructions. As an example, the race committee may broadcast a “C” flag in combination with audio instructions to alter the course of the race. Participants who have joined the race committee's channel will see the flag and hear the instructions via the app on their devices.

As another example of a visual display, in a given channel there may be a display of the positions of the channel source and of each participant in the channel. Such a display may be particularly helpful in an application such as emergency response; it also may be helpful for construction workers, warehouse workers, and in other situations. Of course, for the race committee of a sailboat race, it will be helpful to have a display that shows the relative positions of all of the boats participating in the race.

As another example of a visual display, the channel source (or another participant) in a given channel may broadcast a map, floor plan, or other visual aid to channel participants. Again, broadcasting a building floor plan in combination with the positions of channel participants may be particularly helpful in emergency response. Similarly, broadcasting a navigation chart in combination with the positions of channel participants may be particularly helpful to a race committee in a sailboat race. Another application of such a map-plus-position display would be in an ultrarace or other large-scale land-based event where participants may be dispersed across miles of terrain.

Another aspect of the disclosed technology is that a vendor of goods or services may establish a communication channel, via an app on a mobile computing device, that will be available for access by potential customers who also use the app on their respective mobile computing devices. Instances of the app on potential customers' mobile computing devices may display lists of available communication channels, ordered or organized by categories of goods or services and/or by distance from vendor devices to the respective customer device(s). A potential customer may access the list of channels on their respective instance of the app and select a channel from the list by making a user input to their respective mobile computing device. The mobile computing devices may establish a communication link in the selected channel in response to the user input/channel selection. The customer may place an order for a good or service via the communication link. Optionally, the customer also may engage in audio/video communication via the communication link. The customer's instance of the app then may display a payment terminal for the order that was placed.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 depicts a plurality of mobile computing devices, which are implementing a mobile instrument system 100 with communication feature according to aspects of the disclosed technology.

FIG. 2 depicts widgets, which may be displayed by one or more of the mobile computing devices that are shown in FIG. 1.

FIG. 3 depicts a plurality of mobile computing devices, which are implementing an ordering system 300 with communication feature according to aspects of the disclosed technology.

It should be understood that throughout the drawings, corresponding reference numerals indicate like or corresponding parts and features.

The present teachings are described more fully hereafter with reference to the accompanying drawings, which depict example embodiments. The following description illustrates the present teachings by way of example, not by way of limitation of the principles of the present teachings.

### DETAILED DESCRIPTION

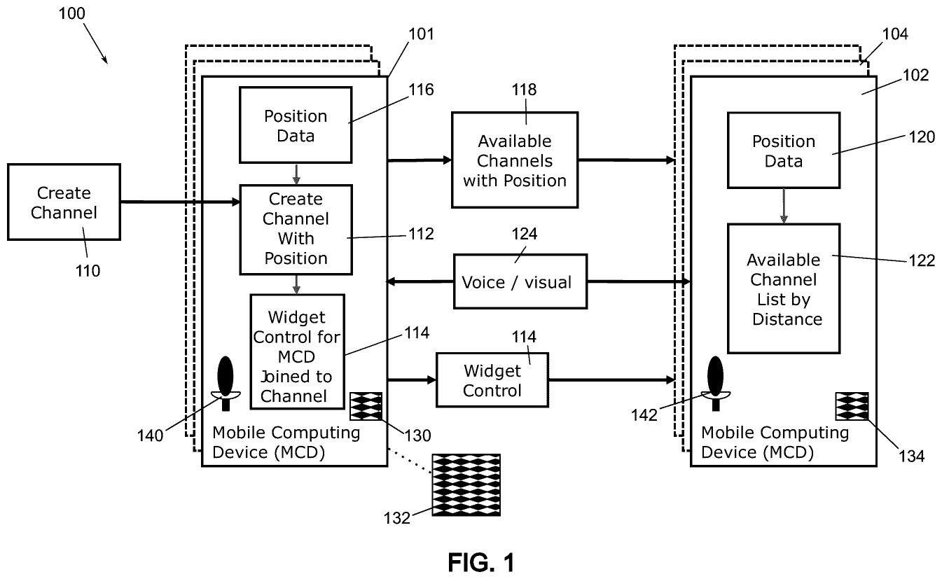

FIG. 1 depicts a plurality of mobile computing devices (MCD) 101, 102, 104, etc., which are implementing a mobile instrument system 100 with communication features according to aspects of the disclosed technology. For example, MCD 100 receives an input 110 to create a channel for audio/visual communication. In response to the input 110, MCD 100 establishes a communication channel 112 along with a widget controller 114 for any MCD that may be joined to the channel. The channel 112 incorporates position data 116 about the location of MCD 100 (channel source for channel 112). MCD 100 broadcasts a list 118 of available channels with the positions of the channel sources; the list 118 includes the channel 112. MCD 100 also broadcasts the widget control 114 to any other MCD that might join the channel 112. MCD 102 has its own position data 118 and receives the channel list 118 from MCD 100 (or from a remote server, not shown, which may maintain the list 118 independent of MCD 100 or 102). Based on its own position data 120, MCD 102 sorts the list 118 to generate a distance-ordered list 122 of available channels. When a user selects the channel 112 from the list 122 on MCD 102, then MCD 102 establishes voice (and possibly visual) communication 124 with MCD 100 via channel 112.

Voice communication is accomplished by speakers 130, 132, 134 and by microphones 140, 142 that may be built into each of the MCDs or wirelessly connected to one or more of the MCDs.

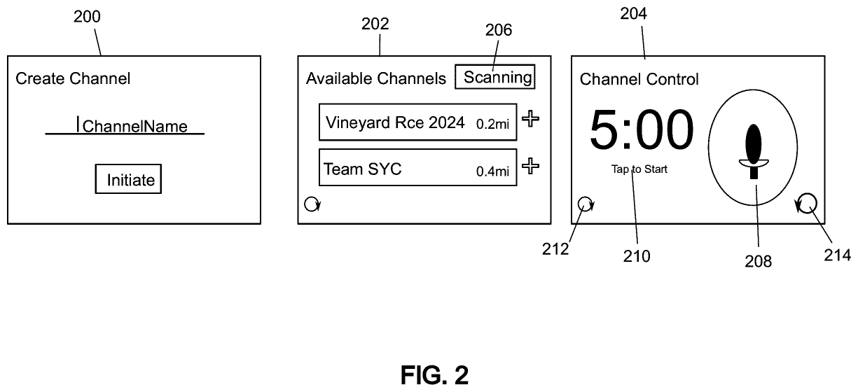

FIG. 2 depicts widgets 200, 202, 204, which may be displayed by one or more of the mobile computing devices that are shown in FIG. 1. Widget 200 is displayed when a user starts to create a channel; it is an input widget for setting up a channel. Widget 202 displays the distance-sorted list 122 of channels. Widget 202 includes a channel scan button 206, which alters its appearance while the app is scanning for channels. Widget 204 is displayed when a user has established communication via a channel; it provides a push-to-talk button 208 and a visual timer 210, along with buttons 212 and 214. The buttons 212, 214 may have various functionality. For example, one of the buttons could cause the app to reset its timer to a default value, e.g., 5 minutes. One of the buttons could cause the timer to cycle among default values such as 10, 6, 5, 4, 3 minutes. One of the buttons, when actuated by a channel source instance of the app, could synchronize all the timers of other users participating in the given channel. One of the buttons could start a pre-countdown timer for a channel source instance of the app; on expiration of the pre-countdown timer, the channel source instance of the app could automatically synchronize and start the timers of other users participating in the given channel.

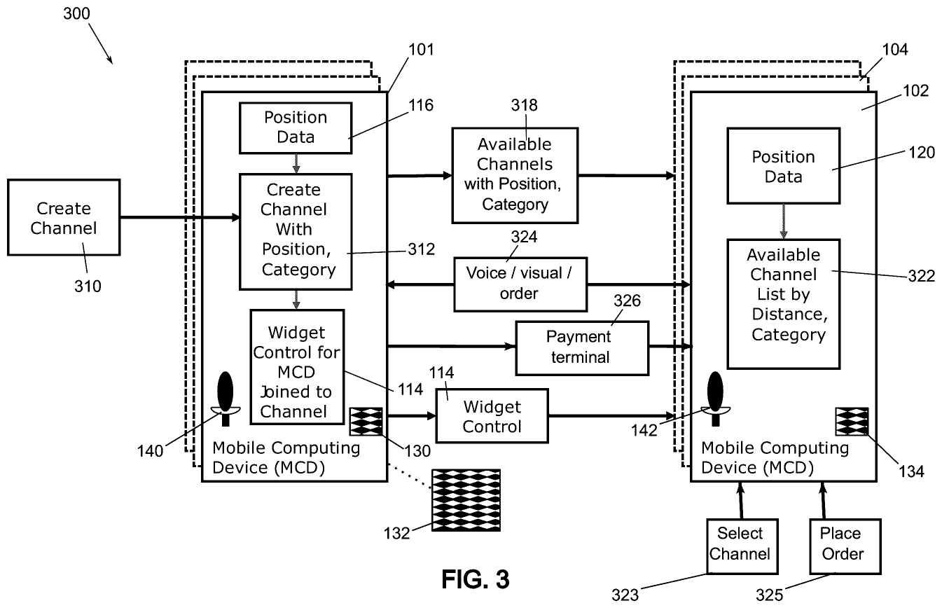

FIG. 3 depicts a plurality of mobile computing devices (MCD) 101, 102, 104, etc., which are implementing an ordering system 300 that supports an app with communication features according to aspects of the disclosed technology. Components of the ordering system 300 that have identical reference numbers to the components of the mobile instrument system 100 are not further described as they are essentially identical. According to the ordering system 300, a user input 310 is received at vendor MCD 101 to create a channel that has a position and at least one category of goods or services. In response to the user input, MCD 101 creates a channel 312 that has position data and a category (or more than one category) of goods and/or services. The plurality of MCDs transmit, via the app, available channels 318 with position and category data. At customer MCD 102, an available channel list 322 is displayed with both distance (from vendor MCD to customer MCD) and category data. The available channel list 322 may be ordered and/or organized by at least one of distance and/or category. In response to the customer selecting 323 a channel, a voice/visual/order communication link 324 is established between the customer MCD 102 and the vendor MCD 101. Voice/visual/order communication then takes place. In response to an order 325 that is placed by a customer via the communication link 324, the vendor MCD 101 sends a payment terminal 326 back to the customer MCD 102 to receive payment for the order. The payment terminal 326 may be integrated into the widget control 114, or may be a separate modal or other entity.

The present teachings have been described in language more or less specific as to structural, mechanical, and functional features. It is to be understood, however, that the present teachings are not limited to the specific features shown and described, since the apparatus, system, and/or method herein disclosed comprises preferred forms of putting the present teachings into effect.

For purposes of explanation and not limitation, specific details are set forth such as particular structures, architectures, interfaces, techniques, etc., in order to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The use of “first,” “second,” etc., for different features/components of the present disclosure are only intended to distinguish the features/components from other similar features/components and not to impart any order or hierarchy to the features/components, unless explicitly stated otherwise. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed is:

1. A mobile instrument system with communication feature, comprising:
a plurality of mobile computing devices each having a display;
one or more speakers associated with said plurality of mobile computing devices;
one or more microphones associated with said plurality of mobile computing devices;
an app executing on each of said plurality of mobile computing devices;
a position of each of said plurality of mobile computing devices, said app having access to said position for the mobile computing device on which it executes;
a channel created by said app executing on one of said plurality of mobile computing devices, said channel including the position of the one of said plurality of mobile computing devices;
a list of available channels displayed by said app on another one of said plurality of mobile computing devices;
a user input on any one of the other ones of said plurality of mobile computing devices selecting an available channel;
a communication link created between mobile computing devices having instances of said app that either created or selected a particular channel; and
a user communication emanating from said speaker associated with at least one of the mobile computing devices that are connected to said communication link.

2. The mobile instrument system of claim 1 further comprising a training parameter for display to mobile computing devices that are connected to said communication link, and wherein the mobile computing device that created said channel can control said training parameter on the other linked mobile computing devices connected to said communication link.

3. The mobile instrument system of claim 2 in which said training parameter is a countdown timer.

4. The mobile instrument system of claim 2 in which said training parameter is a course map.

5. The mobile instrument system of claim 1 in which said plurality of mobile computing devices include a countdown timer.

6. The mobile instrument system of claim 1 in which said speaker is wirelessly connected to at least some of said plurality of mobile computing devices.

7. The mobile instrument system of claim 1 in which said speaker is built into at least one of said plurality of mobile computing devices.

8. The mobile instrument system of claim 1, wherein the list of channels is ordered by a distance of the list from the position of each channel.

9. A mobile instrument system with training feature, comprising:
a plurality of mobile computing devices having a display;
an app executing on each of said plurality of mobile computing devices;
a position of each of said plurality of mobile computing devices, said app having access to said position for the mobile computing device on which it executes;
a channel created by said app executing on one of said plurality mobile computing devices;
a list of available channels displayed by said app on other ones of said plurality of mobile computing devices;
a user input on any one of the other ones of said plurality of mobile computing devices selecting an available channel;
a communication link created between mobile computing devices having instances of said app that either created or selected a particular channel; and
a training parameter for broadcast by the one mobile computing device creating the communication link to the other ones of said plurality of mobile computing devices through said app to control a portion of said app related to said training parameter on the other ones of said plurality of mobile computing devices connected to said communication link.

10. The mobile instrument training system of claim 9 wherein the training parameter further comprises a start time for a race.

11. The mobile instrument training system of claim 9 wherein the training parameter further comprises a position of a mark on a race course.

12. The mobile instrument training system of claim 9 wherein the training parameter further comprises a race instruction.

13. The mobile instrument training system of claim 12 wherein the race instruction further comprises a penalty.

14. The mobile instrument system of claim 9, further comprising a speaker that is wirelessly connected to at least some of said plurality of mobile computing devices.

15. The mobile instrument system of claim 9, further comprising a speaker that is built into at least one of said plurality of mobile computing devices.

16. The mobile instrument system of claim 9, wherein the list of channels is ordered by a distance of the list from the position of each channel.

17. A mobile instrument system with training and communication features, comprising:
a plurality of mobile computing devices having a display;
a speaker associated with each of said plurality of mobile computing devices;
an app executing on each of said plurality of mobile computing devices;
a position of each of said plurality of mobile computing devices, said app having access to said position for the mobile computing device on which it executes;
a channel created by said app executing on one of said plurality mobile computing devices;
a list of available channels displayed by said app on other ones of said plurality of mobile computing devices;
a user input on any one of the other ones of said plurality of mobile computing devices selecting an available channel;
a communication link created between mobile computing devices having instances of said app that either created or selected a particular channel;
a user communication generated on one of the linked mobile computing devices emanating from said speaker associated with at least some of the other linked mobile computing devices connected to said communication link; and
a training parameter for broadcast by the one mobile computing device creating the communication link to the other ones of said plurality of mobile computing devices through said app to control a portion of said app related to said training parameter on the other ones of said plurality of mobile computing devices connected to said communication link.

18. The mobile instrument system of claim 17 wherein said training parameter is displayed to users of other ones of said plurality of mobile computing devices.

19. The mobile instrument system of claim 17 in which said training parameter is a countdown timer.

20. The mobile instrument system of claim 17 in which said training parameter is a course map.

21. The mobile instrument system of claim 17 wherein the training parameter further comprises a start time for a race.

22. The mobile instrument training system of claim 17 wherein the training parameter further comprises a position of a mark on a race course.

23. The mobile instrument training system of claim 17 wherein the training parameter further comprises a race instruction.

24. The mobile instrument training system of claim 23 wherein the race instruction further comprises a penalty.

25. The mobile instrument training system of claim 17, wherein the list of channels is ordered by a distance of the list from the position of each channel.

26. An ordering system comprising:
a plurality of mobile computing devices each having a display;
an app executing on each of the plurality of mobile computing devices, wherein the app has access to the position of each of the mobile computing devices;
a channel created by the app executing on a vendor device of the plurality of mobile computing devices, wherein the channel includes a category of goods or services that may be ordered;
a list of available channels displayed by the app on at least one customer device of the plurality of mobile computing devices, wherein the list of channels is ordered by at least one of (a) category of goods or services and/or (b) distance of the customer device from the vendor device(s) of the channels;
a user input on the customer device;
a communication link created between the customer device and one of the vendor device(s) in response to the user input; and
an order for a good or service submitted from the customer device to the vendor device via the communication link.

27. The ordering system of claim 26, further comprising a payment request created on the vendor device in response to the order, and a payment terminal displayed at the customer device in response to the payment request.

28. The ordering system of claim 26, further comprising a speaker associated with each of the plurality of mobile computing devices.
